(19) United States
(12) Patent Application Publication
(10) Pub. No.: US 2025/0103230 A1
(43) Pub. Date: Mar. 27, 2025

(54) ADJUSTING WORDLINE DISTRIBUTION IN A MEMORY DEVICE BASED ON MODULATION OF HOST DATA

(71) Applicant: Micron Technology, Inc., Boise, ID (US)

(72) Inventors: Dung Viet Nguyen, San Jose, CA (US); Phong S. Nguyen, Livermore, CA (US); James Fitzpatrick, Laguna Niguel, CA (US)

(21) Appl. No.: 18/781,692

(22) Filed: Jul. 23, 2024

Related U.S. Application Data
(60) Provisional application No. 63/539,758, filed on Sep. 21, 2023.

(51) Int. Cl. G06F 3/06

(52) U.S. Cl. CPC G06F 3/0644; G06F 3/0604; G06F 3/0679

(57) ABSTRACT

Host data to be programmed to a plurality of memory cells associated with a wordline of a memory device is received from a host system. The host data into a plurality of partitions is divided. Each of the plurality of partitions is divided into a respective plurality of sub-partitions. One or more modulation mappings to be applied to the plurality of sub-partitions are determined based on the host data of the plurality of partitions. Host data of each sub-partition of the plurality of sub-partitions is modified based on the one or more modulation mappings. The modified host data of each sub-partition is written to the plurality of memory cells associated with the wordline.

### RELATED APPLICATIONS

This application claims the benefit of U.S. Provisional Patent Application No. 63/539,758, filed Sep. 21, 2023, which is incorporated by reference herein.

### TECHNICAL FIELD

Embodiments of the disclosure relate generally to memory sub-systems, and more specifically, relate to adjusting wordline distribution in a memory device of a memory sub-system based on modulation of host data.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1A illustrates an example computing system that includes a memory sub-system in accordance with some embodiments of the present disclosure.

FIG. 1B illustrates an example host data in accordance with some embodiments of the present disclosure.

FIG. 2A illustrates an example modulation mappings data structure in accordance with some embodiments of the present disclosure.

FIG. 2B illustrates an example sub-partition mapping data structure for use in determining a series of modulation mappings in accordance with some embodiments of the present disclosure.

FIG. 2C illustrates another example of a sub-partition mapping data structure for use in determining a series of modulation mappings in accordance with some embodiments of the present disclosure.

FIG. 3 is a flow diagram of an example method to adjust wordline distribution based on modulation of host data in accordance with some embodiments of the present disclosure.

FIG. 4 is a block diagram of an example computer system in which embodiments of the present disclosure may operate.

### DETAILED DESCRIPTION

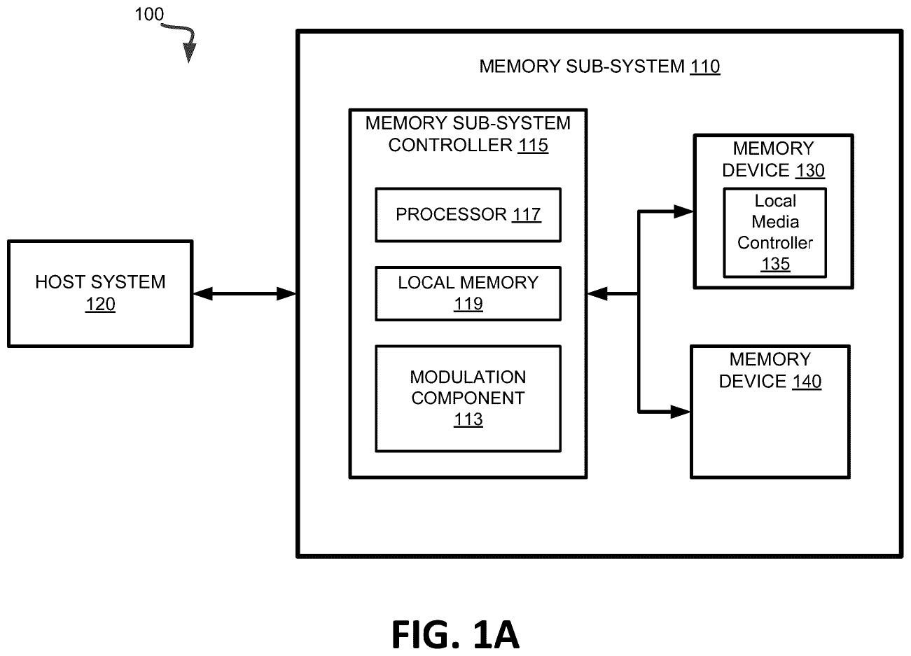

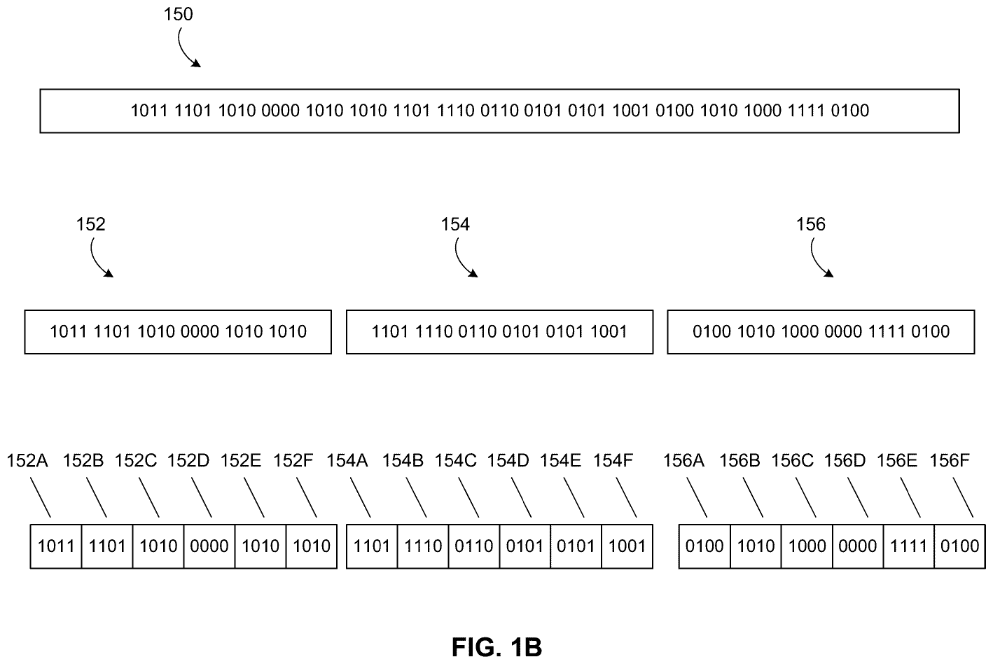

Aspects of the present disclosure are directed to adjust wordline distribution in a memory device based on the modulation of host data, whether that host data is ECC encoded or not, and based on the modulation of any system metadata before programming to memory. A memory sub-system can be a storage device, a memory module, or a combination of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1A. A non-volatile memory device is a package of one or more dies. Each die can includes of one or more planes. For some types of non-volatile memory devices (e.g., NAND devices), each plane includes of a set of physical blocks. Each block includes of a set of wordlines. Each wordline includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Some memory sub-system controllers store data provided by the host system (e.g., host data) at the memory sub-system by randomizing the host data and encoding the host data. The memory device receives the host data from the memory sub-system controller and converts the host data into to a cell charge level to write a cell of a wordline of the memory device. Once converted, the memory device writes the cell charge level to the cell.

Some memory sub-system controllers randomize host data using a scrambler. A scrambler is a circuit that randomizes data by XORing the host data with known random data. Thus, the scrambler outputs a randomized version of the host data (e.g., randomized host data). The memory sub-system controller encodes the randomized host data into a format for storage at the memory sub-system using an encoder. Encoders, such as low density parity check (LDPC) encoder, adds redundancy to protect the randomized host data.

The memory device converts the host data into a cell charge level using a Gray code. A Gray codes represents a one-to-one mapping for a set of binary sequences based on a bit per cell configuration (e.g., single level cells (SLC), multi-level cells (MLCs), triple level cells (TLCs), quad-level cells (QLCs), and penta-level cells (PLCs), etc.). A Gray code translates a binary sequence to the corresponding cell charge level. For example, in QLC which stores 4 bits per cell, a binary sequence of “1111” is translated to L0, a binary sequence of “0111” is translated to L1, a binary sequence of “0011” is translated to L2, and so on until the last binary sequence of “0100” is translated to L15.

Due to the randomization of the host data, the distribution of cell charge levels in a wordline should be uniformly distributed. In other words, a number of cells in a wordline with a specific cell charge level (e.g., L0) should be the same as or similar to a number of cells in the wordline with another cell charge level (e.g., L3). However, due to the physical characteristics of cells of the memory device, the reliability of the host data stored in cells at a specific charge level is less reliable.

Aspects of the present disclosure address the above and other deficiencies by having a memory sub-system that modifies the distribution of the cell charge levels in a wordline in a memory device of the memory sub-system. In one embodiment, host data is received from a host system and randomized, resulting in uniform distribution of cell charge levels. In order to modulate the cell charge levels to match a target distribution, which may be non-uniform in order to optimize reliability, in one embodiment, the memory sub-system controller may partition the host data into a set of partitions and each partition into a set of sub-partitions. The memory sub-system controller can subsequently apply a respective modulation mapping to each sub-partition. Each modulation mapping may flip one or more bits (e.g., upper page bits, lower page bits, extra page bits, etc.) of the host data within the respective sub-partition. The modulation mappings are utilized by the memory sub-system controller to modify the distribution of the cell charges level in a portion of the wordline associated with the sub-partition to match or more closely approximate a target distribution of the cell charge levels. Accordingly, a specific modulation mapping may adjust the characteristics of the selected sub-partition so that the distribution of the cell charge levels conforms to the target distribution of the cell charge levels. In one embodiment, the memory sub-system controller can send the modified host data, along with an indication of the respective modulation mapping used for each sub-partition to the memory device to be written to the target wordline.

Advantages of the present disclosure include, but are not limited to, improving the reliability of the cells associated with a wordline by more precisely modifying the distribution of cell charge levels in the wordline. Using potentially different modulation mappings for each partition and sub-partition can improve the modulation performance, thereby allowing the distribution of cell charge levels to more closely match an ideal target distribution. In addition, using a deterministic assignment of modulation mappings for multiple sub-partitions reduces the memory cells used to store an indication of the modulation mappings, thereby increase the capacity of the memory device available for storing host data.

FIG. 1A illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not- and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not- or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a modulation component 113 that can adjust a wordline distribution by modulating host data. In some embodiments, the memory sub-system controller 115 includes at least a portion of the modulation component 113. In some embodiments, the modulation component 113 is part of the host system 120, an application, or an operating system. In other embodiments, local media controller 135 includes at least a portion of modulation component 113 and is configured to perform the functionality described herein.

The modulation component 113 may receive host data (e.g., host data 150 of FIG. 1B) from host system 120. In some embodiments, the memory sub-system controller 115 may have scrambled the host data using a scrambler (not shown). The modulation component 113 may divide the host data 150 of FIG. 1B into a plurality of partitions (e.g., partitions 152, 154, and 156 of host data 150 of FIG. 1B) based on a predetermined number that indicates a number of partitions. Thus, the number of bits in each partition can be determined by dividing the bits of the host data by the predetermined number, and the number of bits in each partition is used to create the number of partitions to be included in the plurality of partitions.

The modulation component 113 may further divide each partition of the plurality of partitions into a plurality of sub-partitions. For example, as shown in FIG. 1B, partition 152 of host data 150 is divided into a plurality of sub-partitions 152A-F, partition 154 of host data 150 is divided into a plurality of sub-partitions 154A-F, and partition 156 of host data 150 is divided into a plurality of sub-partitions 156A-F. Like the plurality of partitions, the modulation component 113 may divide the host data in a respective partition into a plurality of sub-partitions based on the predetermined number.

In some embodiments, the predetermined number may indicate a number of sub-partitions to be included in the plurality of sub-partitions. Thus, the number of bits in each sub-partition is determined by dividing the bits of the host data in a respective partition by the predetermined number. The number of bits in each sub-partition is used to create the number of sub-partitions to be included in the plurality of sub-partitions. Depending on the embodiment, the predetermined number used to determine the number of bits in each partition may be either the same predetermined number used to determine the number of bits in each sub-partition or a different number.

The modulation component 113 may identify, from a set of combinations of modulation mappings, a combination of modulation mappings to apply to the sub-partitions of the partition. The set of combinations of mappings can be determined based on the host data present in the sub-partitions. In some embodiments, each modulation mapping of the combination of modulation mappings is used to modify a sequence of bits associated with the host data within a respective sub-partition to a specific sequence of bits. The modulation component 113 then converts (e.g., modifies) the sequence of bits associated with the host data within the respective sub-partition to a corresponding sequence of bits indicated by the associated modulation mapping.

In some embodiments, each modulation mapping of the set of modulation mappings is used to conform a sequence of bits associated with the host data to a target distribution of cell charge level of a wordline of the memory device 130. For example, by applying the modulation mappings to the host data, the modulation component 113 may flip the bits in the host data (i.e., “0” bits become “1” bits and “1” bits become “0” bits). The appropriate modulation mappings to be applied can be determined in any number of ways, such as by experimentation. In one embodiment, the modulation component 113 can maintain one or more tables of modulation mappings (e.g., in local memory 119). Depending on the implementation, there can be different sets of modulation mappings for each partition, and different individual modulation mappings for each sub-partition.

In one embodiment, rather than storing all of the individual modulation mappings for each sub-partition with the host data, the modulation component 113 may store only a subset of the modulation mappings (e.g., the first sub-partition modulation mapping) to represent a series of modulation mappings for the plurality of sub-partitions of a respective partition of the host data. The modulation component 113 may query a sub-partition mapping data structure to obtain the series of modulation mappings to be applied to the plurality of sub-partitions. The sub-partition mapping data structure includes a plurality of entries indexed by the first sub-partition modulation mapping (or a predetermined sub-partition modulation mapping). Each entry includes a series of modulation mappings. The series of modulation mappings represent a modulation mapping used for each sub-partition of the plurality of sub-partitions.

Depending on the embodiment, the modulation component 113 may select two or more predetermined sub-partitions of the plurality of sub-partitions (e.g., first and second sub-partition, fifth and tenth sub-partition, etc.). The modulation component 113 may identify modulation mappings to apply to the two or more predetermined sub-partitions from a set of modulation mappings. The modulation component 113 may query the sub-partition mapping data structure using the modulation mappings to be applied to the two or more predetermined sub-partitions to identify an entry, including a series of modulation mappings.

The modulation component 113 may apply each modulation mapping of the series of modulation mappings to each sub-partition of the plurality of sub-partitions. In particular, modulation component 113, sequentially, starting with the first sub-partition, converts (e.g., modifies) each sub-partition of the plurality of sub-partitions with a modulation mapping of the series of modulation mappings, sequentially beginning with the first modulation mapping of the series of modulation mappings.

Once the host data of each sub-partition of the plurality of sub-partition of the respective partition (e.g., the host data of the respective partition) is modified, the modulation component 113 may append, to the host data of the respective partition, the first sub-partition modulation mapping or a value representing the first sub-partition modulation mapping (or the predetermined sub-partition modulation mapping or a value representing the predetermined sub-partition modulation mapping). In some embodiments, the modulation component 113 may append the first sub-partition modulation mapping (or the predetermined sub-partition modulation mapping) to the end of the host data of the respective partition. In some embodiments, the modulation component 113 may append the first sub-partition modulation mapping (or the predetermined sub-partition modulation mapping) to the end of the host data of a predetermined sub-partition of the respective partition (e.g., third sub-partition).

Once each sub-partition of each partition of host data has been modified, the modulation component 113 may send the host data (e.g., collectively, host data associated with each partition) to the memory device 130 and/or 140 to store the host data to a wordline of the memory device. In some embodiments, the memory sub-system controller 115, prior to the modulation component 113 sending the host data to the memory device 130 and/or 140, encodes, using an encoder (not shown) the host data to a format for storage at the memory device 130 and/or 140.

The memory device 130 and/or 140 converts the host data into a cell charge level using a Gray code. Once the host data are converted into their corresponding cell charge levels, the memory device 130 and/or 140 writes the cell charge levels associated with the host data to the wordline of the memory device 130 and/or 140.

The host system may request data to be retrieved from a wordline of the memory device 130 and/or 140. The memory device 130 and/or 140 may use the Gray code (e.g., the inverse of the Gray code) to convert the cell charge levels to host data. The memory device 130 and/or 140 sends the host data to the memory sub-system controller 115. The memory sub-system controller 115 decodes the host data, using a decoder (not shown), from the format for storage at the memory device 130 and/or 140.

The modulation component 113 may divide the host data into a plurality of partitions and then each partition into a plurality of sub-partitions, as discussed above. For each partition of the plurality of partitions, the modulation component 113 may identify, using the predetermined sub-partition of the respective partition, a first sub-partition modulation mapping (or the predetermined sub-partition modulation mapping) appended to the end of the predetermined sub-partition (e.g., third sub-partition). The modulation component 113 may query the sub-partition mapping data structure using the first sub-partition modulation mapping (or the predetermined sub-partition modulation mapping) to obtain the series of modulation mappings used to modify the plurality of sub-partitions of the respective partition. The modulation component 113 may unmodify (or revert), using the series of modulation mappings (e.g., the inverse of the series of modulation mappings), the host data of the respective partition. Once each partition of host data has been unmodified, the memory sub-system controller 115 may descramble the host data (e.g., collectively, host data associated with each partition) and provide the host system 120. Further details with regards to the operations of the modulation component 113 are described below.

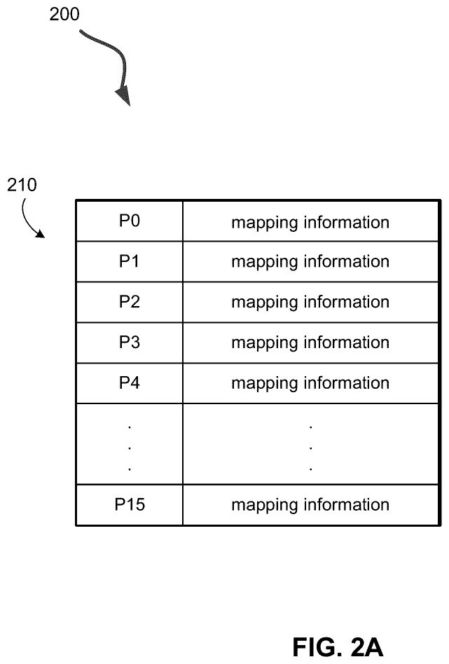

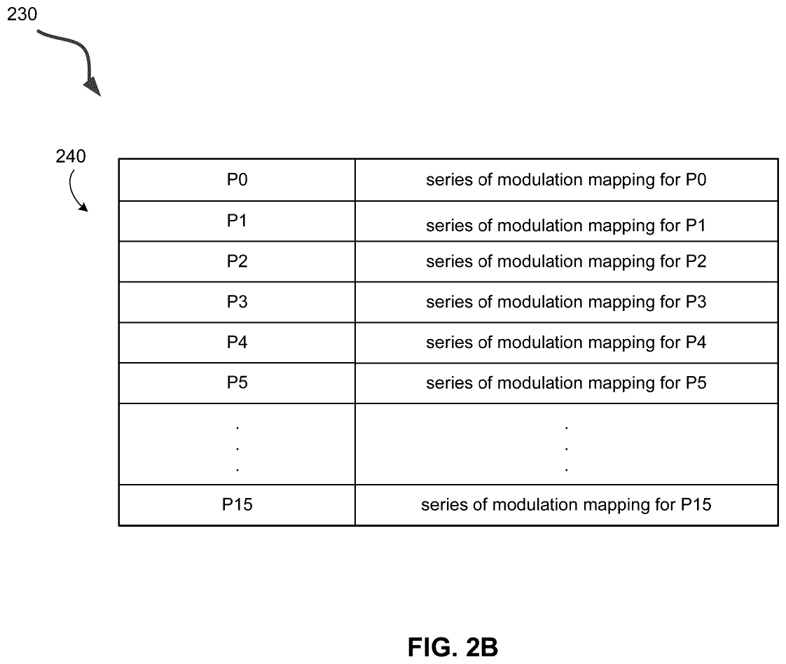

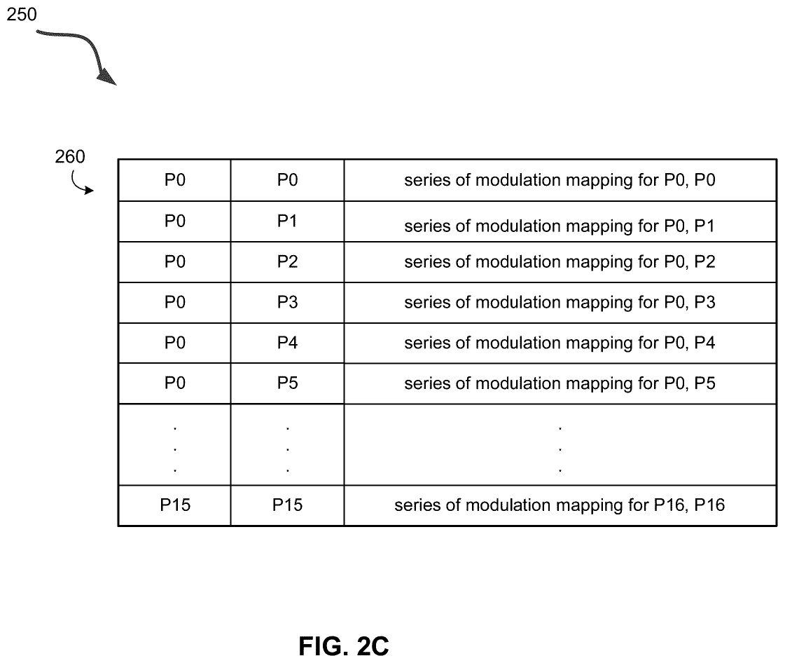

FIG. 2A illustrates an example modulation mappings data structure in accordance with embodiments of the present disclosure. In one embodiment, the modulation mappings data structure 200 includes a plurality of entries 210. Each entry 210 includes information regarding the corresponding modulation mapping. As previously described, when the modulation component 113 of FIG. 1A identifies, from a set of modulation mappings, a modulation mapping to apply to the predetermined sub-partition (e.g., the first sub-partition). The modulation component 113 retrieves, from the modulation mappings data structure 200, information (e.g., mapping information) associated with each modulation mapping of the set of modulation mappings. In one embodiment, the host data includes a sequence of bits to be stored in one or more memory cells associated with a given wordline of the memory device 130. When configured as QLC memory, each memory cell can store a level of charge at a given programming level representing a certain four value. The sequence of bits representing the various programming levels of the host data in the sub-partitions can be used to query the modulation mappings data structure to identify an entry 210 that matches the sequence of bits of the host data. The mapping information of the entry 210 (e.g., mapping information of P2) is retrieved from the modulation mappings data structure 200 and can be applied to the host data of the sub-partitions. The modulation mapping information for each of P0-15 can include a corresponding value to which the initial value of the data in a given sub-partition can be changed. For example, if the sequence of bits in the initial data is “0101”, modulation component 113 can determine that this sequence of bits matches that of a certain one of entries 210 (e.g., P2) in mapping data structure 200. The mapping information of P2, for example, can indicate that the initial value “0101” can be changed to a modulated value of “1010”. Modulation component 113 can thus store the modulated value, along with an indication that the modulation mapping information from data structure 200 was used to generate the modulated value, in the memory device 130.

FIG. 2B illustrates an example sub-partition mapping data structure for use in determining a series of modulation mappings in accordance with embodiments of the present disclosure. The sub-partition mapping data structure 230 includes a plurality of entries 240. Each entry 240 is referenced by a first sub-partition modulation mapping (or predetermined sub-partition modulation mapping) and includes a series of modulation mappings. As previously described, the modulation component 113 of FIG. 1A queries the sub-partition mapping data structure 230, to obtain a series of modulation mappings to be applied to the plurality of sub-partitions. The series of modulation mappings (e.g., P2, P1, P4, P0, P6, . . . ) associated with the entry identified by the first sub-partition modulation mapping (or predetermined sub-partition modulation mapping) (e.g., P2) is retrieved and can be applied to the data from a number of sub-partitions. Thus, there can be a different modulation mapping for each sub-partition, however, an indication of each different modulation mapping need not be stored with the data on memory device 130. Since each series of modulation mappings can be uniquely identified by one or more of the sub-partition modulation mappings (e.g., the first modulation mapping or the first ‘k’ modulation mappings), only those one more sub-partition modulation mappings need be stored. Modulation component 113 can subsequently identify the full series of modulation mappings from the corresponding entry in data structure 230.

FIG. 2C illustrates another example of a sub-partition mapping data structure for use in determining a series of modulation mappings in accordance with embodiments of the present disclosure. The sub-partition mapping data structure 250 includes a plurality of entries 260. Each entry 260 is referenced by two or more predetermined sub-partition modulation mapping and includes a series of modulation mappings. As previously described, the modulation component 113 of FIG. 1A, using the two or more predetermined sub-partition modulation mappings (e.g., first sub-partition modulation mapping (e.g., P0) and second sub-partition modulation mapping (e.g., P1)) can locate the corresponding row of sub-partition mapping data structure 260 to obtain a series of modulation mappings to be applied to the plurality of sub-partitions. The series of modulation mappings (e.g., P0, P1, P4, P0, P6, . . . ) associated with the entry identified by the two or more predetermined sub-partition modulation mapping (e.g., P1, P2) is retrieved. The modulation component 113 of FIG. 1A applies each modulation mapping identified in the modulation mappings data structure 200 to the corresponding sub-partitions to to modify the respective sub-partition.

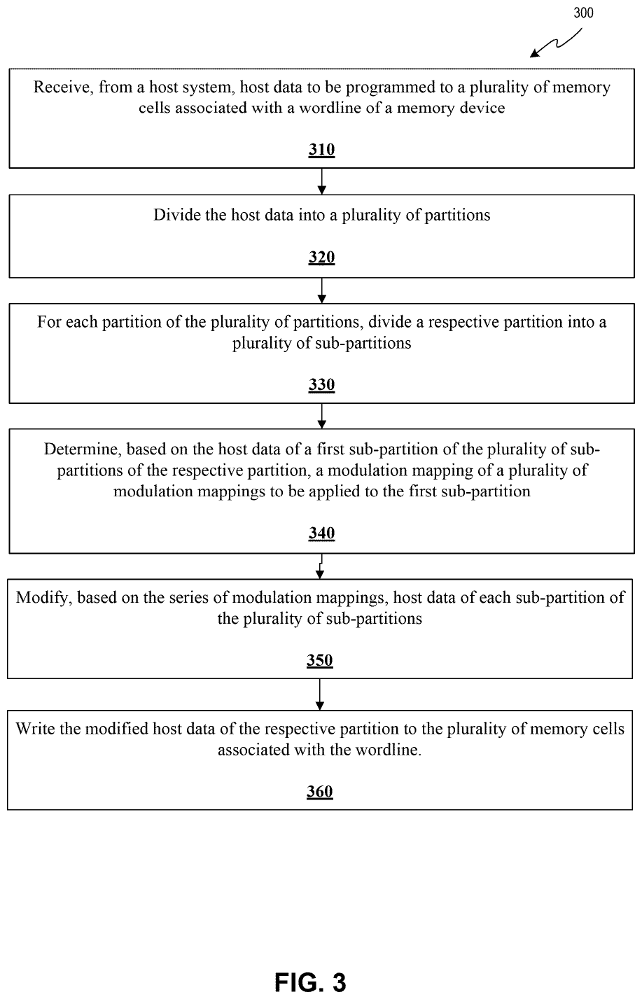

FIG. 3 is a flow diagram of an example method 300 to adjust wordline distribution based on modulation of host data in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the modulation component 113 of FIG. 1A. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic receives host data from a host system to be programmed to a plurality of memory cells associated with a wordline of a memory device, such as memory device 130. As previously described, the host data may be scrambled.

At operation 320, the processing logic divides the host data into a plurality of partitions. For example, host data 150 of FIG. 1B is divided into a plurality of partitions 152, 154, and 156 of FIG. 1B. In one embodiment, the number of bits in each partition is predetermined (e.g., according to the parameters of the modulation algorithm being applied). The number of partitions can vary depending on the size of the host data, for example.

At operation 330, for each partition of the plurality of partitions, the processing logic divides a respective partition into a plurality of sub-partitions. For example, partition 152 of host data 150 of FIG. 1B is divided into a plurality of sub-partitions 152A-F, partition 154 of host data 150 is divided into a plurality of sub-partitions 154A-F, and partition 156 of host data 150 is divided into a plurality of sub-partitions 156A-F. In one embodiment, the number of bits in each sub-partition is predetermined (e.g., according to the parameters of the modulation algorithm being applied). The number of sub-partitions for each partition can vary depending on the size of the host data, for example.

At operation 340, the processing logic determines, based on the host data of the plurality of sub-partitions, a modulation mapping to be applied to the sub-partitions. As previously described, the processing logic analyzes the host data of the partitions. As described above, the modulation mapping can be stored in a modulation mappings data structure, and can include a number of entries each indicating a certain value present in the host data of a given sub-partition, and a modulated value to which that host data in the given sub-partition is to be changed. In some embodiments, each modulation mapping may flip one or more bits of the host data within a sub-partition of the plurality of sub-partitions. Depending on the embodiment, each entry can store a single modulation mapping for a single sub-partition or a series of modulation mappings for a series of sub-partitions. When a series of modulation mappings are included, the series may be identified by an identifier of one or more sub-partitions, where the remaining modulation mappings are deterministically identified.

At operation 350, the processing logic modifies, based on the modulation mappings, host data of each sub-partition of the plurality of sub-partitions. As previously described, each modulation mapping may flip one or more bits of the host data within a sub-partition of the plurality of sub-partitions. For example, a modulation mapping may indicate that the upper page and lower page of a sequence of bits should be flipped (e.g., bit sequence “1011” should be modified according to the modulation mapping to bit sequence “0111”). As previously described, each modulation mapping of the series of modulation mappings is applied to each sub-partition of the plurality of sub-partitions sequentially.

At operation 360, the processing logic writes the modified host data of the respective partition to the plurality of memory cells associated with the wordline. In some embodiments, writing the modified host data of the respective partition to the plurality of memory cells associated with the wordline includes appending, to the modified host data, a mapping value representing an entry of the sub-partition mapping data structure associated with the identified series of modulation mappings used to modify the host data. The mapping value can be later read with the modified host data so that the processing logic can reverse the modulation and obtain the original host data.

Depending on the embodiment, responsive to receiving a request to read host data from the plurality of memory cells associated with the wordline, the processing logic obtains the series of modulation mappings from an entry of the sub-partition mapping data structure identified by the appended value of the modified host data. The processing logic then reverts the modified host data back to the host data using the obtained series of modulation mappings.

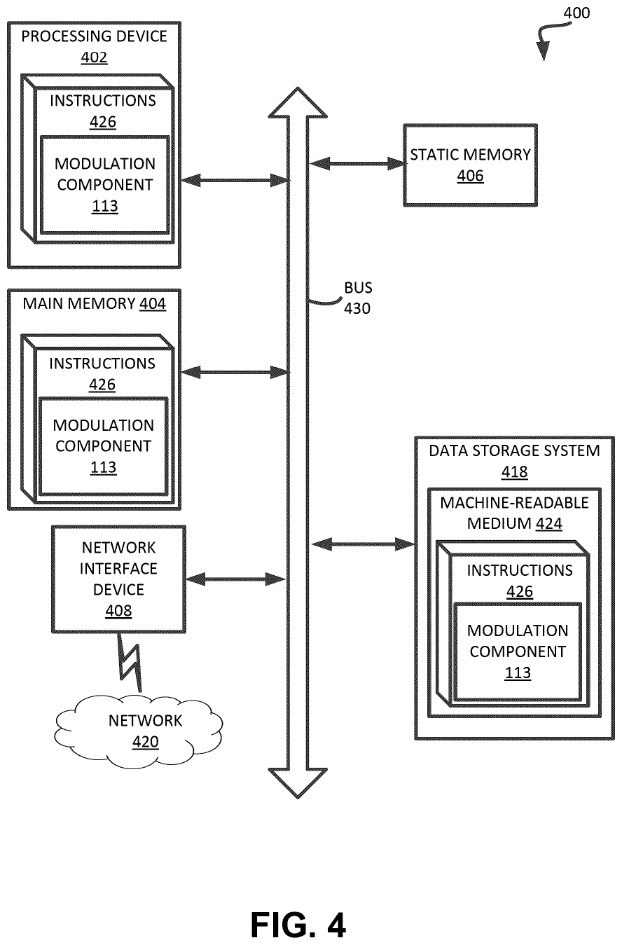

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the modulation component 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1A.

In one embodiment, the instructions 426 include instructions to implement functionality corresponding to a modulation component (e.g., the modulation component 113 of FIG. 1A). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, from a host system, host data to be programmed to a plurality of memory cells associated with a wordline of a memory device;
dividing the host data into a plurality of partitions;
dividing each of the plurality of partitions into a respective plurality of sub-partitions;
determining, based on the host data of the plurality of partitions, one or more modulation mappings to be applied to the plurality of sub-partitions;
modifying, based on the one or more modulation mappings, host data of each sub-partition of the plurality of sub-partitions; and
writing the modified host data of each sub-partition to the plurality of memory cells associated with the wordline.

2. The method of claim 1, wherein each entry of a sub-partition mapping data structure comprises the one or more modulation mappings.

3. The method of claim 1, wherein each modulation mapping flips one or more bits of the host data within a sub-partition of the plurality of sub-partitions.

4. The method of claim 1, wherein the host data is divided into the plurality of partitions based on a first predetermined value.

5. The method of claim 1, wherein each partition of the plurality of partitions is divided into the plurality of sub-partitions based on a second predetermined value.

6. The method of claim 1, wherein writing the modified host data of each sub-partition to the plurality of memory cells associated with the wordline comprises appending, to the modified host data, a mapping value representing an entry of the sub-partition mapping data structure associated with the one or more modulation mappings used to modify the host data.

7. The method of claim 6, further comprising:
responsive to receiving a request to read host data from the plurality of memory cells associated with the wordline, obtaining the one or more modulation mappings from an entry of the sub-partition mapping data structure identified by the appended mapping value of the modified host data; and
reverting, using the one or more modulation mappings, the modified host data back to the host data.

8. A system comprising:
a plurality of memory devices; and
a processing device, operatively coupled with the plurality of memory devices, to perform operations comprising:
receiving, from a host system, host data to be programmed to a plurality of memory cells associated with a wordline of a memory device;
dividing the host data into a plurality of partitions;
dividing each of the plurality of partitions into a respective plurality of sub-partitions;
determining, based on the host data of the plurality of partitions, one or more modulation mappings to be applied to the plurality of sub-partitions;
modifying, based on the one or more modulation mappings, host data of each sub-partition of the plurality of sub-partitions; and
writing the modified host data of each sub-partition to the plurality of memory cells associated with the wordline.

9. The system of claim 8, wherein each entry of a sub-partition mapping data structure comprises the one or more modulation mappings.

10. The system of claim 8, wherein each modulation mapping flips one or more bits of the host data within a sub-partition of the plurality of sub-partitions.

11. The system of claim 8, wherein the host data is divided into the plurality of partitions based on a first predetermined value.

12. The system of claim 8, wherein each partition of the plurality of partitions is divided into the plurality of sub-partitions based on a second predetermined value.

13. The system of claim 8, wherein writing the modified host data of each sub-partition to the plurality of memory cells associated with the wordline comprises appending, to the modified host data, a mapping value representing an entry of the sub-partition mapping data structure associated with the one or more modulation mappings used to modify the host data.

14. The system of claim 13, wherein the processing device is to perform operations further comprising:
responsive to receiving a request to read host data from the plurality of memory cells associated with the wordline, obtaining the one or more modulation mappings from an entry of the sub-partition mapping data structure identified by the appended mapping value of the modified host data; and
reverting, using the one or more modulation mappings, the modified host data back to the host data.

15. A non-transitory computer-readable storage medium comprising instructions that, when executed by a processing device, cause the processing device to perform operations comprising:
receiving, from a host system, host data to be programmed to a plurality of memory cells associated with a wordline of a memory device;
dividing the host data into a plurality of partitions;
dividing each of the plurality of partitions into a respective plurality of sub-partitions;
determining, based on the host data of the plurality of partitions, one or more modulation mappings to be applied to the plurality of sub-partitions;
modifying, based on the one or more modulation mappings, host data of each sub-partition of the plurality of sub-partitions; and
writing the modified host data of each sub-partition to the plurality of memory cells associated with the wordline.

16. The non-transitory computer-readable storage medium of claim 15, wherein each entry of a sub-partition mapping data structure comprises the one or more modulation mappings.

17. The non-transitory computer-readable storage medium of claim 15, wherein each modulation mapping flips one or more bits of the host data within a sub-partition of the plurality of sub-partitions.

18. The non-transitory computer-readable storage medium of claim 15, wherein the host data is divided into the plurality of partitions based on a first predetermined value, and wherein each partition of the plurality of partitions is divided into the plurality of sub-partitions based on a second predetermined value.

19. The non-transitory computer-readable storage medium of claim 15, wherein writing the modified host data of each sub-partition to the plurality of memory cells associated with the wordline comprises appending, to the modified host data, a mapping value representing an entry of the sub-partition mapping data structure associated with the one or more modulation mappings used to modify the host data.

20. The non-transitory computer-readable storage medium of claim 19, wherein the processing device is to perform operations further comprising:
responsive to receiving a request to read host data from the plurality of memory cells associated with the wordline, obtaining the one or more modulation mappings from an entry of the sub-partition mapping data structure identified by the appended mapping value of the modified host data; and
reverting, using the one or more modulation mappings, the modified host data back to the host data.
